(19) United States
(12) Patent Application Publication
(10) Pub. No.: US 2016/0042675 A1
(43) Pub. Date: Feb. 11, 2016

(54) DEVICE FOR DISPLAYING A LUMINOUS MESSAGE ON THE FAIRING OF AN AIRCRAFT

(71) Applicant: AIRCELLE, GONFREVILLE L'ORCHER (FR)

(72) Inventors: Christophe MARCHETTI, CAUBIAC (FR); Jerome REBIERE-DESVEAUX, GRATENTOUR (FR); Serge RIERE, COLOMIERS (FR)

(73) Assignee: AIRCELLE, GONFREVILLE L'ORCHER (FR)

(21) Appl. No.: 14/922,361

(22) Filed: Oct. 26, 2015

Related U.S. Application Data
(63) Continuation of application No. PCT/FR2014/050982, filed on Apr. 23, 2014.

(30) Foreign Application Priority Data
Apr. 26, 2013 (FR) 1353877

(51) Int. Cl. G09F 21/10; B64D 47/02

(52) U.S. Cl. CPC G09F 21/10; B64D 47/02

(57) ABSTRACT

A device for displaying an luminous message on the fairing of an aircraft includes: an electroluminescent sheet plated against the fairing; a means for attaching the electroluminescent sheet onto the fairing; a means for supplying the electroluminescent sheet with electricity; a means for electrically connecting the electroluminescent sheet to the means for supplying electricity; and a means for controlling the electroluminescent sheet in an powered-on state, in which the electroluminescent sheet is supplied with electricity and emits light, or in a powered-off state, in which the electroluminescent sheet is inoperative.

### CROSS-REFERENCE TO RELATED APPLICATIONS

This application is a continuation of International Application No. PCT/FR2014/050982, filed on Apr. 23, 2014, which claims the benefit of FR13/53877, filed on Apr. 26, 2013. The disclosures of the above applications are incorporated herein by reference.

### FIELD

The present disclosure relates to a device for displaying a luminous message on the fairing of an aircraft.

### BACKGROUND

The statements in this section merely provide background information related to the present disclosure and may not constitute prior art.

It is known to affix on the fairing of an aircraft an information message, such as a registration number.

It is meant by fairing the external wall, or the casing, of the aircraft in its broad sense, thus comprising the external wall of a turbomachine nacelle as well as the external wall of a wing of the aircraft for example.

The display of this type of message is usually carried out by means of an adhesive film plated on the fairing of the aircraft, or by means of a drawing achieved by painting directly on the fairing.

We have discovered that this type of message, which is intended to be seen from the outside of the aircraft, is that it is visible only when some visibility conditions are fulfilled.

Indeed, in foggy or rainy weather or at night, the message may not be seen properly or may not be visible.

### SUMMARY

The present disclosure provides a device allowing this type of message to be seen from outside the aircraft, whatever the visibility conditions.

For this purpose, the present disclosure proposes a device for displaying a luminous message on the fairing of an aircraft, characterized in that it includes:

at least one electroluminescent sheet plated on the fairing,

a means for attaching the electroluminescent sheet on the fairing,

a means for supplying the electroluminescent sheet with electricity,

an electrical means for joining the electroluminescent sheet on the electricity supply means, and

a means for controlling the electroluminescent sheet in a lighted state in which the electroluminescent sheet is supplied with electricity and emits light, or in a switched-off state in which the electroluminescent sheet is inoperative;

Thus, the device according to the present disclosure allows making the message displayed on the fairing of the aircraft visible whatever the visibility conditions.

According to another feature, the fairing includes successively, from the inside to the outside of the aircraft:

a plate forming a support substrate,

a first coating stage,

a second stage for displaying the message comprising the electroluminescent sheet and the associated attaching means,

an external protective layer,

The second stage for displaying the message has the lowest possible thickness, for limiting the overthickness formed on the fairing.

To this end, the electroluminescent sheet is devoid of protection, the protection being provided by the external protective layer applied on the fairing after attaching the electroluminescent sheet.

More particularly, the protective layer is a transparent varnish for protecting against ultraviolet radiation.

According to another aspect, the electroluminescent sheet is cut out according to the shape of the luminous message to be displayed.

In addition, the means for attaching the electroluminescent sheet is constituted of an adhesive film.

Furthermore, the electricity supply means is arranged inside the aircraft, and the electrical means for joining the electroluminescent sheet includes at least two electric wires which electrically join the electroluminescent sheet and the electricity supply means, and which pass through at least one hole arranged in the fairing of the aircraft.

Advantageously, the electroluminescent sheet displays an information message.

Likewise, the electroluminescent sheet may also display an advertising message.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an overall side view, which illustrates an aircraft including a turbomachine nacelle equipped with a device for displaying a luminous message according to the present disclosure;

FIG. 2 is a perspective detailed view, which illustrates the nacelle of FIG. 1 equipped with the display device; and

FIG. 3 is a schematic detailed view in section along line 3-3 of FIG. 2, which illustrates the arrangement of the electroluminescent sheet of the device for displaying on the nacelle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the description and claims, in order to clarify the description and claims, it will be adopted in a non-limiting manner the terms longitudinal, vertical and transversal in reference to the trihedral L, V, T indicated in the Figures.

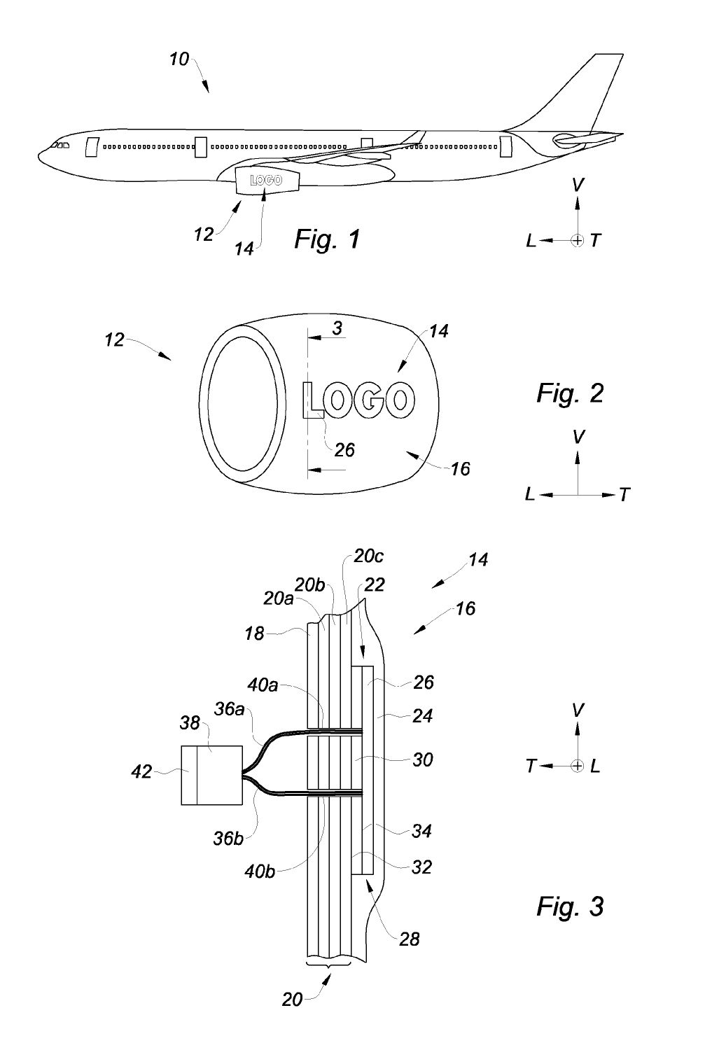

It has been represented on FIG. 1 an aircraft 10 including a turbomachine nacelle 12 which is equipped with a device 14 for displaying a luminous message on the fairing 16 of the aircraft 10.

Here, the term “fairing” designates the external wall, or the casing, of the aircraft 10 in its broadest sense, which comprises the external wall of the nacelle 12 as well as the external wall of a wing of the aircraft 10 for example.

As can be seen on the diagram on FIG. 3, the fairing 16 of the nacelle 12 is constituted, from the inside to the outside of the nacelle 12, a plate 18 forming a support substrate, a first coating stage 20, a second stage 22 for displaying the message and an external protective layer 24.

Here the plate 18 is produced in a carbon alloy. However, in a non-limiting manner, the plate 18 may be produced from a metallic aluminum sheet for example or from any other suitable support.

The first coating stage 20 is constituted of a first layer 20a of protective paint, a second layer 20b of support paint, a third layer 20c of finishing paint.

The first layer 20a allows in particular to protect the plate 18 from corrosion and outside aggressions. It is constituted of a layer of epoxide polymer based paint for example.

The second layer 20b is a layer of paint forming a paint base of uniform color intended to support the third layer 20c of finishing paint.

The second stage 22 includes four electroluminescent sheets 26 belonging to the display device 14, which are each attached on the fairing 16 by an attaching means 28.

Each electroluminescent sheet 26 forms an isolated element of the message to be displayed.

The message to be displayed is the word “LOGO” according to the form described here, each letter of this message forming an isolated element, that is to say, an element which is not connected with an adjacent element.

The message to be displayed may be an advertising logo, or an information message or any other type of visual message.

The electroluminescent sheets 26 are cut out according to the shape of luminous message to be displayed.

According to the example described here, each electroluminescent sheet 26 is cut out such as to delimit a letter of the message to be displayed.

In order to facilitate the comprehension of the description, only the electroluminescent sheet 26 representing the first letter “L” of the message, represented schematically in section on FIG. 3, and called “electroluminescent sheet 26” hereafter, is described in detail in the rest of the description.

The electroluminescent sheet 26 comes in the form of a flexible film with the finest possible thickness, for limiting the overthickness formed on the fairing 16 of the aircraft 10.

To this end, the electroluminescent sheet 26 is devoid of a protective film against ultraviolet radiation which is usually present, thanks to which the electroluminescent sheet 26 has a thickness of around two hundred micrometers.

In addition, the attaching means 28 associated with the electroluminescent sheet 26 is constituted of a flexible adhesive film 30 of “double sided” type which is covered with glue on each of its faces, one first face 32 being stuck on the third finishing layer 20c of the first coating stage 20 and a second face 34 being stuck on the electroluminescent sheet 26.

The adhesive film 30 has a thickness of around one hundred micrometers, such that the assembly constituted by the adhesive film 30 and the electroluminescent sheet 26 has a low thickness of three hundred micrometers.

Nevertheless, according to a variant, the attaching means 28 may be produced by projecting glue in the form of an aerosol on the first coating stage 20 of the fairing 16.

Finally, the protective layer 24 is a layer of transparent protective varnish, which is applied on the fairing 16 for covering the electroluminescent sheet 26 and the third 20c layer of finishing paint.

This protective layer 24 allows protecting the electroluminescent sheet 26 and the third layer 20c of finishing paint, in particular against bad weather and ultraviolet radiation.

The varnish used for forming the protective layer 24 here has a thickness of about seventy micrometers.

According to another aspect, the display device 14 includes a first wire 36a and a second wire 36b forming an electric connecting means for electrically connecting the electroluminescent sheet 26 on an associated electricity supply means.

With reference to FIG. 3, each wire 36a, 36b includes a first end electrically connected to the electroluminescent sheet 26 and a second end electrically connected to the associated supply means 38.

To this end, a first piercing 40a and a second piercing 40b are arranged in the fairing 16 through the plate 18, the first coating stage 20 and the attaching means 28 of the electroluminescent sheet 26, for the passage of the first wire 36a and the second wire 36b respectively.

The supply means 38 is a source of direct current which is arranged inside the aircraft 10 and which delivers a voltage of twelve to one hundred and ten Volts. The supply means 38 here is constituted by one of the direct current networks which usually equips the aircraft 10.

Nevertheless, the supply means 38 may be constituted by an independent electric energy source, such as an electric battery for example.

In addition, the display device 14 includes a means 42 for controlling the electroluminescent sheet 26 in a lighted state in which the electroluminescent sheet 26 is electrically supplied so as to emit light, or in a switched-off state in which the electroluminescent sheet 26 is inoperative.

Thus, when the electroluminescent sheet 26 occupies its lighted state, the message drawn by the electroluminescent sheet 26 is visible on the fairing 16 of the aircraft 10 even in conditions of low visibility and/or low luminosity.

The control means 42 may be driven by a member of the aircraft 10 crew for example, via a man-machine interface.

According to another form, an opening is arranged in the second layer 20b of support paint and the third layer 20c of finishing paint, for example by means of a stencil.

The opening is of the shape of the message to be displayed and the electroluminescent sheets 26 for delimiting a housing in which the electroluminescent sheets are attached by the attaching means 28.

This variant allows limiting the overthickness formed on the fairing 16 by the assembly constituted by the electroluminescent sheets 26 and the associated attaching means 28.

Each electroluminescent sheet 26 may use the organic light-emitting diode technology, known by the OLED acronym.

What is claimed is:

1. An aircraft including a device for displaying a luminous message on a fairing of the aircraft, said device comprising:
at least one electroluminescent sheet in a form of a flexible film, plated on the fairing;
an attaching means for attaching said at least one electroluminescent sheet on the fairing;
an electricity supply means for supplying said at least one electroluminescent sheet with electricity;
an electrical means for connecting said at least one electroluminescent sheet to the electricity supply means; and
a means for controlling said at least one electroluminescent sheet in a lighted state in which said at least one electroluminescent sheet is supplied with electricity and emits light, or in a switched-off state in which said at least one electroluminescent sheet is inoperative,
wherein the fairing includes successively, from an inside to an outside of the aircraft:
a plate forming a support substrate;
a first coating stage;
a second stage for displaying the luminous message comprising said at least one electroluminescent sheet and the attaching means, said at least one electroluminescent sheet not having a film for protecting against ultraviolet radiation, and
an external protective layer being a transparent varnish for protecting against ultraviolet radiation, the external protective layer being applied on the fairing of the aircraft for covering said at least one electroluminescent sheet and a layer of a finishing paint.

2. The aircraft according to claim 1, wherein an opening is arranged in a layer of a support paint and the layer of the finishing paint.

3. The aircraft according to claim 2, wherein the opening is arranged by means of a stencil.

4. The aircraft according to claim 2, wherein the opening is of a shape of the luminous message to be displayed and of said at least one electroluminescent sheet for delimiting a housing in which said at least one electroluminescent sheet is attached by the attaching means.

5. The aircraft according to claim 1, wherein said at least one electroluminescent sheet has a thickness of about 200 micrometers.

6. The aircraft according to claim 1, wherein said at least one electroluminescent sheet is a cut out according to a shape of the luminous message to be displayed.

7. The aircraft according to claim 1, wherein the attaching means for attaching said at least one electroluminescent sheet is constituted of an adhesive film.

8. The aircraft according to claim 1, wherein the electricity supply means is arranged inside the aircraft, and the electrical means includes at least two electric wires which electrically connect said at least one electroluminescent sheet and the electricity supply means, and which pass through at least one hole arranged in the fairing of the aircraft.

9. The aircraft according to claim 1, wherein said at least one electroluminescent sheet displays an information message or an advertising message.

10. The aircraft according to claim 1, wherein the aircraft comprises a nacelle of a turbomachine, the nacelle being equipped with the device for displaying the luminous message on the fairing of the aircraft.

11. A device for displaying a luminous message on a fairing of an aircraft, said device comprising:
at least one electroluminescent sheet in a form of a flexible film, plated on the fairing;
an attaching means for attaching said at least one electroluminescent sheet on the fairing;
an electricity supply means for supplying said at least one electroluminescent sheet with electricity;
an electrical means for connecting said at least one electroluminescent sheet to the electricity supply means; and
a means for controlling said at least one electroluminescent sheet in a lighted state in which said at least one electroluminescent sheet is supplied with electricity and emits light, or in a switched-off state in which said at least one electroluminescent sheet is inoperative, and
wherein the fairing includes successively, from an inside to an outside of the aircraft:
a plate forming a support substrate;
a first coating stage;
a second stage for displaying the luminous message comprising said at least one electroluminescent sheet and the attaching means, said at least one electroluminescent sheet not having a film for protecting against ultraviolet radiation; and
an external protective layer being a transparent varnish for protecting against ultraviolet radiation, the external protective layer being applied on the fairing of the aircraft for covering said at least one electroluminescent sheet and a layer of a finishing paint.

12. The device according to claim 11, wherein an opening is arranged in a layer of a support paint and the layer of the finishing paint.

13. The device according to claim 12, wherein the opening is arranged by means of a stencil.

14. The device according to claim 12, wherein the opening is of a shape of the luminous message to be displayed and of said at least one electroluminescent sheet for delimiting a housing in which said at least one electroluminescent sheet is attached by the attaching means.

15. The device according to claim 11, wherein said at least one electroluminescent sheet has a thickness of about 200 micrometers.

16. The device according to claim 11, wherein said at least one electroluminescent sheet is a cut out according to a shape of the luminous message to be displayed.

17. The device according to claim 11, wherein the attaching means is constituted of an adhesive film.

18. The device according to claim 11, wherein the electricity supply means is arranged inside the aircraft, and the electrical means for connecting said at least one electroluminescent sheet includes at least two electric wires which electrically connect said at least one electroluminescent sheet and the electricity supply means, and which pass through at least one hole arranged in the fairing of the aircraft.

19. The device according to claim 11, wherein said at least one electroluminescent sheet displays an information message or an advertising message.
